(19) United States
(12) Patent Application Publication
(10) Pub. No.: US 2009/0210261 A1
(43) Pub. Date: Aug. 20, 2009

(54) System and Method for Multi-Modal Travel Shopping

(75) Inventor: William Charles Mortimore, JR., San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc., Foster City, CA (US)

(21) Appl. No.: 12/034,424

(22) Filed: Feb. 20, 2008

(51) Int. Cl. G06Q 99/00

(52) U.S. Cl. 705/5

(57) ABSTRACT

One embodiment provides a method, that may be implemented on a system, for obtaining a starting point and a destination point for a traveler; identifying multiple options of transportation modes to travel from the starting point to the destination point, and identifying a costs and travel time associated respectively with each transportation mode to travel from a departure terminal to an arrival terminal; identifying respectively for each transportation mode, a costs and travel time associated with local transportation from the starting point to a departure terminal, and identifying a costs and travel time associated with local transportation from an arrival terminal to the destination point; presenting to the traveler for selection, the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; receiving a selection of a transportation mode and reserving the transportation associated with the respective transportation mode.

### BACKGROUND OF THE INVENTION

When traveling from one major city to another, in several areas a traveler may be able to select from a variety of inter-city travel modes. For example, in the northeast corridor of the United States, a traveler may select from competitive options that offer travel by bus, train, or airplane, especially between some of cities that are fairly close to one another, such as Boston to New York or New York to Philadelphia. Depending on the time of day and other factors, the different options may be very competitive, both in cost and in time. It is often hard for a traveler to decide which travel mode to use, because even though he can compare the cost of a ticket for each inter-city carrier, other factors, such as the cost of getting to and from the carrier terminal, parking fees, tolls, and time of local ground travel may vary considerably. Therefore, factoring in the time and cost of the ground transport to and from the travel terminal can result in substantial differences in time and cost among various competitive inter-city carriers. Also, in some areas, taking a local public carrier, such as a taxi or limousine, across a state or county line can result in a very expensive extra charge, while in other places, there is no extra charge.

### SUMMARY

Some embodiments of the present invention are summarized in this section.

One embodiment provides a method, that may be implemented on a system, for obtaining a starting point and a destination point for a traveler; identifying multiple options of transportation modes to travel from the starting point to the destination point, and identifying a costs and travel time associated respectively with each transportation mode to travel from a departure terminal to an arrival terminal; identifying respectively for each transportation mode, a costs and travel time associated with local transportation from the starting point to a departure terminal, and identifying a costs and travel time associated with local transportation from an arrival terminal to the destination point; presenting to the traveler for selection, the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; receiving a selection of a transportation mode and reserving the transportation associated with the respective transportation mode.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DESCRIPTION OF THE EMBODIMENTS

The disclosure is illustrated by way of example and not limitation in the figures of the accompanying drawings in which like references indicate similar elements.

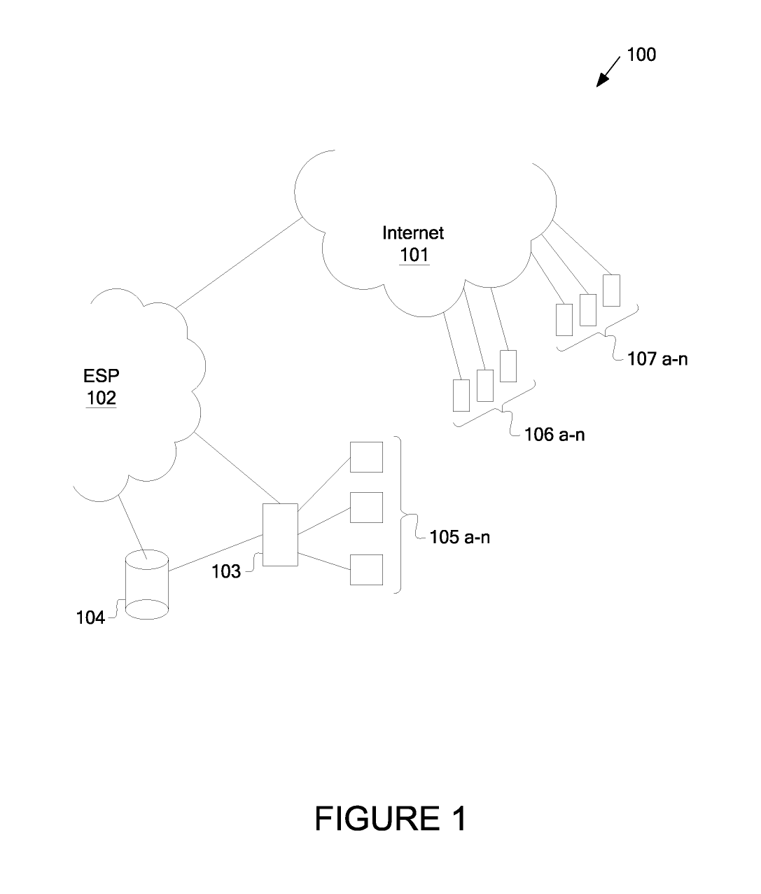

FIG. 1 shows an exemplary overview of a system according to one embodiment of the current invention;

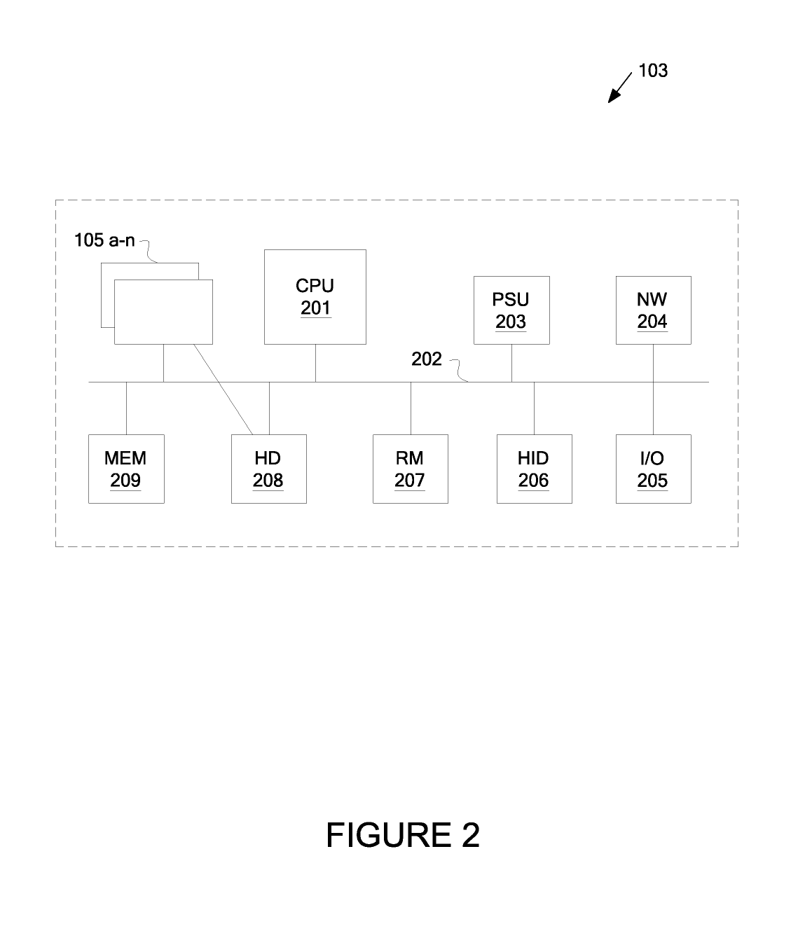

FIG. 2 shows an architectural diagram of an exemplary computer such as a server, according to one embodiment;

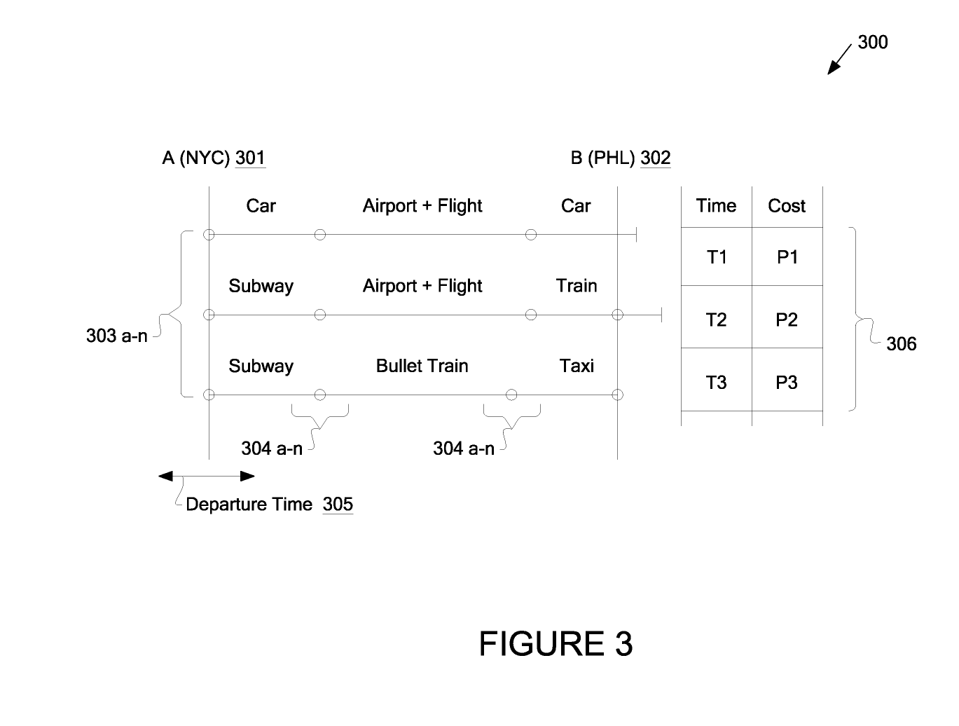

FIG. 3 shows an exemplary screen shot, in accordance with one embodiment; and

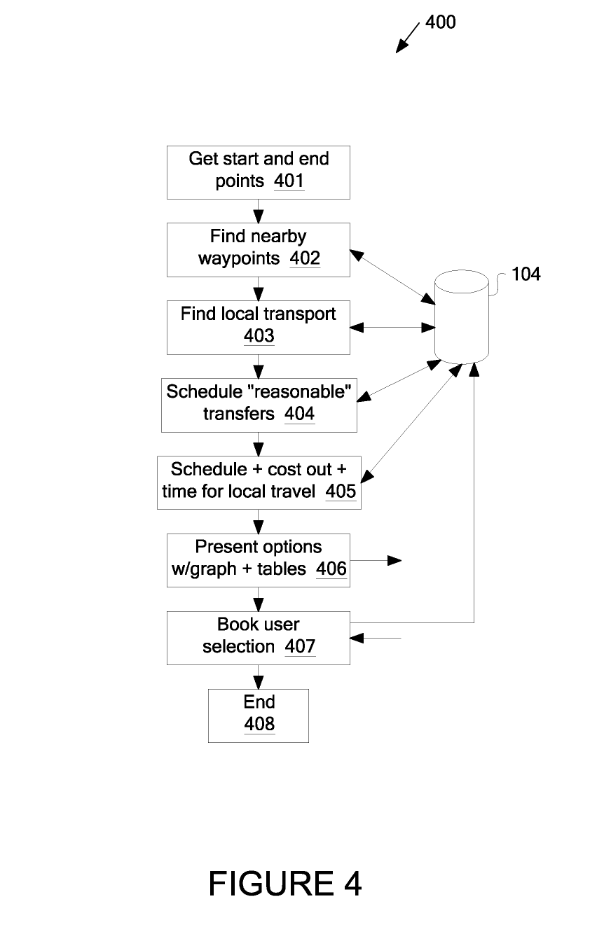

FIG. 4 shows an exemplary process for implementation of the system, according to one embodiment of the present invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary system 100 according to one embodiment of the current invention. An electronic services portal (ESP) 102 connects to a server 103 and a data repository 104. The server hosts software instances 105a-n of the present invention, plus basic elements of the overall system, such as the operating system, as well as any other inherently needed or present software, which, depending on the implementation of the system, may be one, several, or many instances. These software instances are to be considered only exemplary indications of how the software could be installed in server 103 and how it could work in conjunction with ESP 102, Personal Information Managers (PIMs, not shown), and main data repository 104. System 102 connects via Internet 101 to system users 106a-n and suppliers 107a-n. It is clear that these connections could also be made through a direct connection, through a phone system, or through any other suitable networking method, known or to be invented.

FIG. 2 shows a simplified architectural diagram of an exemplary computer such as server 103. Server 103 contains a CPU 201; a system bus 202; power supply unit 203; network interface 204; input/output (I/O) unit 205; a human interface device 206, which may or may not be present; removable media drive 207, which may be used to load software into the computer; hard drive 208, on which the software may be installed; and memory 209, which may include both RAM and nonvolatile memory for software such as a basic input output system (BIOS) and other system software, such as an operating system, for example Microsoft® Windows®, Linux®, or any other, similar suitable software. It is clear that in a networked environment many of these elements could be moved to one or more other computer(s) and could communicate over a network (as connected to by network interface 204, for example, typically an Ethernet or similar type of network) with system 103, but, essentially, all these elements together are required to properly operate a computer and to run the software instances 105a-n, which are typically installed on the hard drive, even if said hard drive is not a local hard drive.

FIG. 3 shows a simplified exemplary screen shot 300, which both helps to explain the method of cost and time comparisons and also presents an exemplary table of results of the comparison calculations. In this example a traveler must go from point A 301 in New York city to point B 302 in Philadelphia. In this case, three inter-city transportation options are available. The first two options 304a and 304b both include airports as waypoints and an airline flight as the mode for inter-city travel; while the third option 303c includes train stations as waypoints and a bullet train as the mode for inter-city travel. Depending on the starting location in New York City, for example, the system may consider flights out of both JFK and La Guardia airports, and also the high-speed bullet train from Grand Central Station. Those different inter-city departure and arrival terminals are shown are waypoints 304a-n. The terminal waypoints are selected depending on the location of starting point A and destination point B. For example, if the starting point is on the New Jersey side, the system may offer Newark instead of JFK as a departure point. Also, slider 305 allows the traveler to adjust the desired departure time. Sliding the departure time may change the presented trip options 303a-n. Table 306 presents a summary of trip options 303a-n, showing the actual estimated total transit times T1, T2, and T3 from point A to point B for each of options 303a-n, and the associated total costs P1, P2, and P3.

FIG. 4 shows an exemplary process 400 for implementation of the system according to one embodiment of the present invention. In step 401, the system gets the starting and end points of the trip, by any of various means, such as obtaining them from a traveler's address book in data store 104, or by manual entry via HID 206, or some other means. In step 402, the system finds suitable nearby waypoints, such as travel terminals (airports, train stations, etc.), from any of various sources, including data store 104, information sources available over the Internet, and other information sources. In step 403, the system likewise finds local transportation modes, such as bus, subway, train, personal automobile, rented car, public carrier services such as taxi or limousine, bicycle, etc. In some cases, the system may need to include fixed or additional costs in the cost of local transportation, such as bridge or road tolls, parking, luggage handling, etc. In step 404, a “reasonable” transfer schedule is presented, based on the distance between departure point A 301 to the first waypoint 304a (i.e., airport, train station, etc.) and time required to be at the waypoint 301 to catch the next local transportation. The user may adjust the earliest departure time, respective to the starting point, by manipulating (i.e., sliding) the start point 301 along the time line 305. In step 405, the system firms up a schedule with a complete cost-out for each of the different variations and complete time calculations, including the local travel. In a preferences section in a local travel menu (not shown), the user may customize his traveler profile, or in some cases the preferences may be entered for this travel instance by or on behalf of the traveler, or both (not shown). Such customizations may allow a traveler to select certain local and long-distance travel modes or to omit certain modes. For example, the traveler may or may not have access to a personal automobile, so he may include or omit personal automobile as a local transit option, accordingly. In step 406, the system presents to the traveler the feasible travel options, with schedules and costs. Selection of options may also be filtered or modified due to corporate business travel contracts or agreements with various carriers, allowing discounts and other benefits; similar constraints may apply due to various corporate travel rules about cost and scheduling. In step 407, the user indicates his selections to the system and the system then books the carriers for each of the selected travel legs from point A to point B. At step 408, the system terminates the process.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSIs), application-specific integrated circuits (ASICs), and firmware such as electrically erasable programmable read-only memory (EEPROMs).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
obtaining a starting point and a destination point for a traveler;
automatically identifying multiple options of transportation modes to travel from the starting point to the destination point, and identifying a costs and travel time associated respectively with each transportation mode to travel from a departure terminal to an arrival terminal;
automatically identifying respectively for each transportation mode, a costs and travel time associated with local transportation from a starting point to a departure terminal, and identifying a costs and travel time associated with local transportation from an arrival terminal to the destination point;
automatically presenting to the traveler for selection the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; and
receiving a selection of a transportation mode and reserving the transportation associated with the respective transportation mode.

2. The computer-implemented method of claim 1, wherein the multiple options of transportation modes include common transportation modes with separate departure terminals or separate arrival terminals.

3. The computer-implemented method of claim 1, wherein the departure terminal and arrival terminals for each transportation mode are selected relative to the starting point and destination point of the traveler.

4. The computer-implemented method of claim 1, further comprising obtaining the starting point and destination point from the traveler's electronic address book.

5. The computer-implemented method of claim 1, wherein the local transportation comprises one or more of a bus, a subway, a train, a personal automobile, a rented automobile, or public carrier services.

6. The computer-implemented method of claim 5, wherein costs associated with local transportation comprises one or more of bridge or road tolls, parking, or luggage handling.

7. The computer-implemented method of claim 1, wherein the multiple options of transportation modes for selection further comprises a tool to manipulate a departure time from the starting point.

8. The computer-implemented method of claim 1, further comprising identifying the options of the transportation modes based on identified travel preferences of the traveler.

9. The computer-implemented method of claim 1, further comprising identifying the local transportation based on identified travel preferences of the traveler.

10. The computer-implemented method of claim 1, further comprising identifying the options of the transportation modes or the local transportation, based on pre-established travel agreements between one or more carriers and an agency associated with the traveler.

11. The computer-implemented method of claim 1, further comprising identifying the options of the transportation modes or the local transportation, based on pre-established travel rules established by an employer of the traveler.

12. A machine readable medium having stored thereon a set of instructions which when executed perform a method comprising:
obtaining a starting point and a destination point for a traveler;
identifying multiple options of transportation modes to travel from the starting point to the destination point, and identifying a costs and travel time associated respectively with each transportation mode to travel from a departure terminal to an arrival terminal;
identifying respectively for each transportation mode, a costs and travel time associated with local transportation from a starting point to a departure terminal, and identifying a costs and travel time associated with local transportation from an arrival terminal to the destination point;
presenting to the traveler for selection the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; and
receiving a selection of a transportation mode and reserving the transportation associated with the respective transportation mode.

13. The machine readable medium of claim 12, wherein the multiple options of transportation modes include common transportation modes with separate departure terminals or separate arrival terminals.

14. The machine-readable medium of claim 12, further comprising obtaining the starting point and destination point from the traveler's electronic address book.

15. The machine-readable medium of claim 12, wherein costs associated with local transportation comprises one or more of bridge or road tolls, parking, or luggage handling.

16. The machine-readable medium of claim 15, wherein the multiple options of transportation modes for selection further comprises a tool to manipulate a departure time from the starting point.

17. The machine-readable medium of claim 12, further comprising identifying the options of the transportation modes based on identified travel preferences of the traveler.

18. The machine-readable medium of claim 12, further comprising identifying the local transportation based on identified travel preferences of the traveler.

19. The machine-readable medium of claim 12, further comprising identifying the options of the transportation modes or the local transportation, based on pre-established travel agreements between one or more carriers and an agency associated with the traveler.

20. A system comprising:
a means for obtaining a starting point and a destination point for a traveler;
a means for identifying multiple options of transportation modes to travel from the starting point to the destination point, and identifying a costs and travel time associated respectively with each transportation mode to travel from a departure terminal to an arrival terminal;
a means for identifying respectively for each transportation mode, a costs and travel time associated with local transportation from a starting point to a departure terminal, and identifying a costs and travel time associated with local transportation from an arrival terminal to the destination point;
a means for presenting to the traveler for selection the multiple options of transportation modes to travel from the starting point to the destination point, including costs and travel time associated respectively with each option of transportation mode, including local transportation from the starting point to the departure terminal, from the departure terminal to the arrival terminal, and local transportation from the arrival terminal to the destination point; and
a means for receiving a selection of a transportation mode and reserving the transportation associated with the respective transportation mode.
